(19) United States
(12) Patent Application Publication
(10) Pub. No.: US 2026/0194650 A1
(43) Pub. Date: Jul. 9, 2026

(54) RADAR IMAGING APPARATUS, RADAR IMAGING METHOD, AND NON-TRANSITORY COMPUTER-READABLE MEDIUM

(71) Applicant: NEC Corporation, Minato-ku, Tokyo (JP)

(72) Inventors: Tatsuya SUMIYA, Tokyo (JP); Masayuki ARIYOSHI, Tokyo (JP); Toshiyuki NOMURA, Tokyo (JP); Kazumine OGURA, Tokyo (JP)

(73) Assignee: NEC Corporation, Minato-ku, Tokyo (JP)

(21) Appl. No.: 18/863,762

(22) PCT Filed: Apr. 26, 2023
(86) PCT No.: PCT/JP2023/016477

§ 371 Date: Nov. 7, 2024

(30) Foreign Application Priority Data
May 11, 2022 (JP) 2022-078309

(51) Int. Cl. G01S 13/89

(52) U.S. Cl. CPC G01S 13/89

(57) ABSTRACT

A radar imaging apparatus generates, in a case of acquiring a radar signal by controlling an antenna that receives a reflected wave of an electromagnetic wave irradiated to a target space P, based on the radar signal, a two-dimensional image indicating a state of a predetermined height region S that is located at a predetermined height in the target space P and extends in a two-dimensional direction. Subsequently, the radar imaging apparatus detects a target object region T including a predetermined target object from the two-dimensional image. Then, based on the radar signal, the radar imaging apparatus generates a three-dimensional image indicating a state of a portion (imaging space U) that is a partial space in the target space P and through which the target object region T passes at a time that the target object region T is moved in a height direction of the target space P.

### TECHNICAL FIELD

The present invention relates to a radar imaging apparatus, a radar imaging method, and a storage medium.

### BACKGROUND ART

There is a technique in which an electromagnetic wave such as a millimeter wave is irradiated, an image is generated based on a signal of a reflected wave of the irradiated electromagnetic wave, and various inspections such as an inspection of personal belongings are performed, based on the image. Related techniques are disclosed in Patent Document 1, and Non-Patent Documents 1 and 2.

Patent Document 1 and Non-Patent Document 1 disclose a technique for generating a radar image, based on a radar signal acquired by measurement using an electromagnetic wave such as a millimeter wave.

Non-Patent Document 2 discloses a technique in which, first, a position of a target object is determined by generating an image with low resolution but covering a wide range, based on only a signal acquired by a small number of antennas collected in a relatively narrow area, and then an image with high resolution is generated by limiting to a periphery of the determined target object, based on a signal acquired by a large number of antennas spread over a wide range.

### RELATED DOCUMENT

### Patent Document

Patent Document 1: International Patent Publication No. WO2020/261525

### Non-Patent Document

Non-Patent Document 1: S. S. Ahmed, A. Schiessl, F. Gumbmann, M. Tiebout, S. Methfessel and L. Schmidt, “Advanced Microwave Imaging,” in IEEE Microwave Magazine, vol. 13, no. 6, pp. 26-43, September-October 2012, doi: 10.1109/MMM.2012.2205772.
Non-Patent Document 2: F. Adib et al., “Capturing the Human Figure Through a Wall,” ACM Transactions on Graphics, Vol. 34, No. 6, Article 219, 2015.

### DISCLOSURE OF THE INVENTION

### Technical Problem

In a case where it is required to set an orientation of a target object or the like to a predetermined state at a time of performing various inspections such as an inspection of personal belongings, convenience is poor and work efficiency is also deteriorated. In a case where a state of the target object is not restricted, and various inspections such as the inspection of personal belongings can be performed while the target object moves in a predetermined space, for example, the above-described inconvenience is solved.

However, there is a measurement position in which a reflected wave from a target object is easily captured while the target object moves even though the target object is inclined. In a case where such a measurement position is to be included, a width of a target space P to be imaged needs to be sufficiently wider than a radar opening as illustrated in FIG. 13. As a result, in a case where a three-dimensional image indicating a state of the entire target space P is generated, a computation amount of a computer becomes enormous, and thereby a problem of a processing burden on the computer or a problem of processing time may be occurred. Patent Document 1 and Non-Patent Document 1 do not disclose the problem and the solution thereof.

By using the technique disclosed in Non-Patent Document 2, it is possible to narrow a region in which an image with high resolution is generated, and thus it is possible to reduce the above-described problem. However, in a case of the technique disclosed in Non-Patent Document 2, as illustrated in FIG. 14, a radar opening at a time of generating an image with low resolution is narrowed. Due to this, a region in which a target object can be detected also narrows. In FIG. 14, as a result of the narrowing of the radar opening, a scene in which a target object Q (a target object Q located at an end of the target space P) that could be detected In a case where the radar opening is wide as illustrated in FIG. 13 becomes not enable to be detected is illustrated.

In view of the above-described problem, one example of an object of the present invention is to provide a radar imaging apparatus, a radar imaging method, and a program that solve a problem of reducing a processing load on a computer while suppressing detection omission of a target object in a technique for allowing the target object existing in a target space to be detected regardless of an orientation of the target object.

### Solution to Problem

According to one example aspect of the present invention, there is provided a radar imaging apparatus including:
a radar signal acquisition unit that acquires a radar signal by controlling an antenna that receives a reflected wave of an electromagnetic wave irradiated to a target space;
a first image generation unit that generates, based on the radar signal, a two-dimensional image indicating a state of a predetermined height region that is located at a predetermined height in the target space and extends in a two-dimensional direction;
a target object region detection unit that detects a target object region including a predetermined target object from the two-dimensional image; and a second image generation unit that generates, based on the radar signal, a three-dimensional image indicating a state of a portion that is a partial space in the target space and through which the target object region passes at a time that target object region is moved in a height direction of the target space.

According to one example aspect of the present invention, there is provided a radar imaging method including,
by a computer:
   acquiring a radar signal by controlling an antenna that receives a reflected wave of an electromagnetic wave irradiated to a target space;
generating, based on the radar signal, a two-dimensional image indicating a state of a predetermined height region that is located at a predetermined height in the target space and extends in a two-dimensional direction;
detecting a target object region including a predetermined target object from the two-dimensional image; and
generating, based on the radar signal, a three-dimensional image indicating a state of a portion that is a partial space in the target space and through which the target object region passes at a time that the target object region is moved in a height direction of the target space.

According to one example aspect of the present invention, there is provided a program causing a computer to function as:
a radar signal acquisition unit that acquires a radar signal by controlling an antenna that receives a reflected wave of an electromagnetic wave irradiated to a target space;
a first image generation unit that generates, based on the radar signal, a two-dimensional image indicating a state of a predetermined height region that is located at a predetermined height in the target space and extends in a two-dimensional direction;
a target object region detection unit that detects a target object region including a predetermined target object from the two-dimensional image; and
a second image generation unit that generates, based on the radar signal, a three-dimensional image indicating a state of a portion that is a partial space in the target space and through which the target object region passes at a time that the target object region is moved in a height direction of the target space.

### Advantageous Effects of Invention

According to one example aspect of the present invention, a radar imaging apparatus, a radar imaging method, and a program that solve a problem of reducing a processing load on a computer while suppressing detection omission of a target object in a technique for allowing the target object existing in a target space to be detected regardless of an orientation of the target object are achieved.

### BRIEF DESCRIPTION OF THE DRAWINGS

The object described above and other objects, features, and advantages will become more apparent from the public example embodiments described below and the following accompanying drawings.

FIG. 1 It is a diagram illustrating one example of a functional block diagram of a radar imaging apparatus.

FIG. 2 It is a diagram for describing one example of processing of the radar imaging apparatus.

FIG. 3 It is a diagram illustrating one example of a hardware configuration of the radar imaging apparatus.

FIG. 4 It is a diagram illustrating one example of a target space.

FIG. 5 It is a diagram illustrating another example of the target space.

FIG. 6 It is a diagram illustrating another example of the target space.

FIG. 7 It is a flowchart illustrating one example of a flow of processing of the radar imaging apparatus.

FIG. 8 It is a diagram illustrating another example of a functional block diagram of the radar imaging apparatus.

FIG. 9 It is a diagram for describing another example of processing of the radar imaging apparatus.

FIG. 10 It is a diagram illustrating one example of a functional block diagram of the radar imaging apparatus.

FIG. 11 It is a diagram for describing processing of generating a two-dimensional projection image by projecting a three-dimensional image.

FIG. 12 It is another diagram for describing processing of generating a two-dimensional projection image by projecting a three-dimensional image.

FIG. 13 It is a diagram for describing a problem of the present invention.

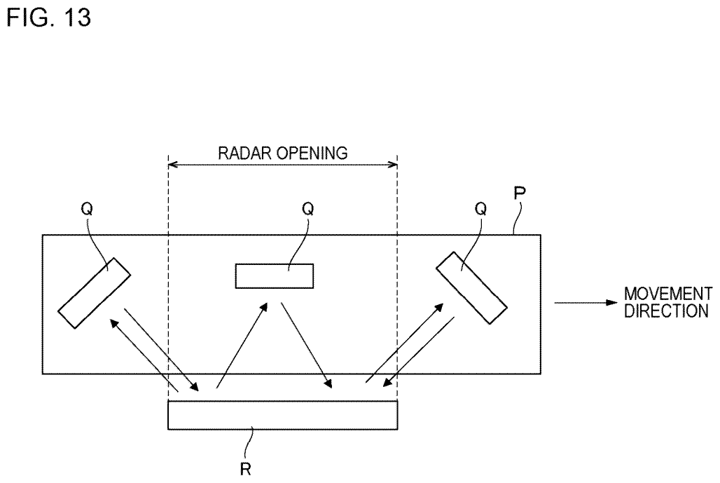

FIG. 14 It is another diagram for describing the problem of the present invention.

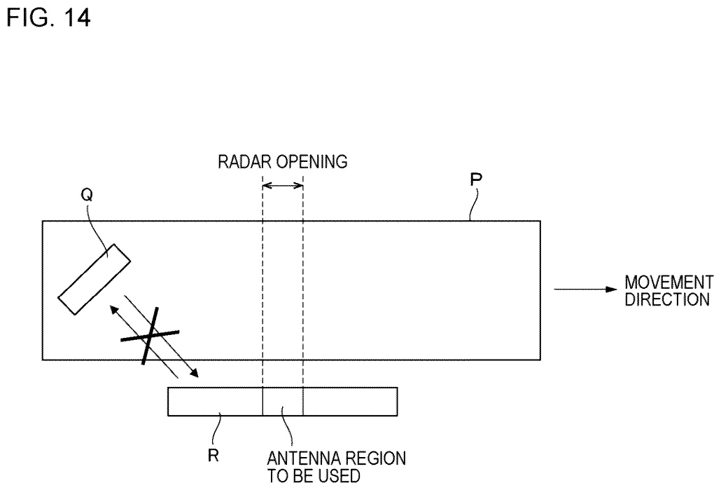

### EXAMPLE EMBODIMENT

Hereinafter, example embodiments of the present invention will be described with reference to the drawings. Note that, in all the drawings, a similar component is denoted by a similar reference sign, and description thereof will be omitted as appropriate.

### First Example Embodiment

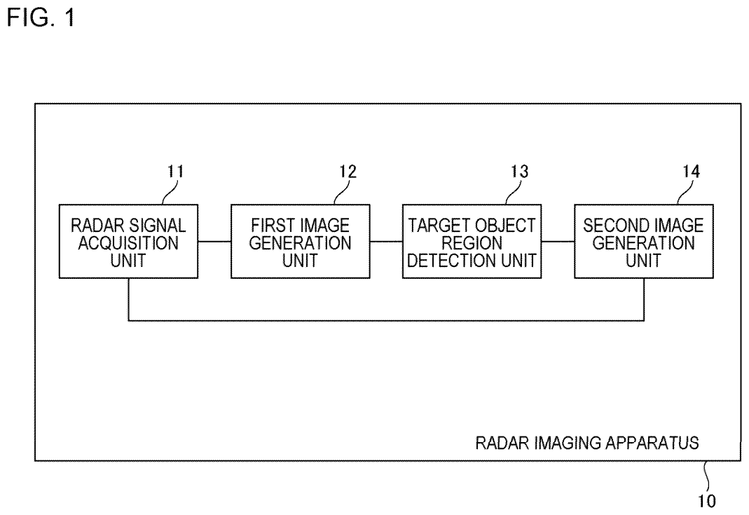

FIG. 1 is a functional block diagram illustrating an outline of a radar imaging apparatus 10 according to a first example embodiment. The radar imaging apparatus 10 includes a radar signal acquisition unit 11, a first image generation unit 12, a target object region detection unit 13, and a second image generation unit 14.

The radar signal acquisition unit 11 acquires a radar signal by controlling an antenna that receives a reflected wave of an electromagnetic wave irradiated to a target space. Based on the radar signal acquired by the radar signal acquisition unit 11, the first image generation unit 12 generates a two-dimensional image indicating a state of a predetermined height region that is located at a predetermined height in the target space and extends in a two-dimensional direction. The target object region detection unit 13 detects a target object region including a predetermined target object from the two-dimensional image generated by the first image generation unit 12. Based on the radar signal acquired by the radar signal acquisition unit 11, the second image generation unit 14 generates a three-dimensional image indicating a state of a portion (space) that is a partial space in the target space and through which the target object region passes at a time that the target object region is moved in a height direction of the target space.

According to the radar imaging apparatus 10 including such a configuration, in a technique for allowing a target object existing in a target space to be detected regardless of an orientation of the target object, it is possible to solve a problem of reducing a processing load on a computer while suppressing detection omission of the target object.

### Second Example Embodiment

### “Outline”

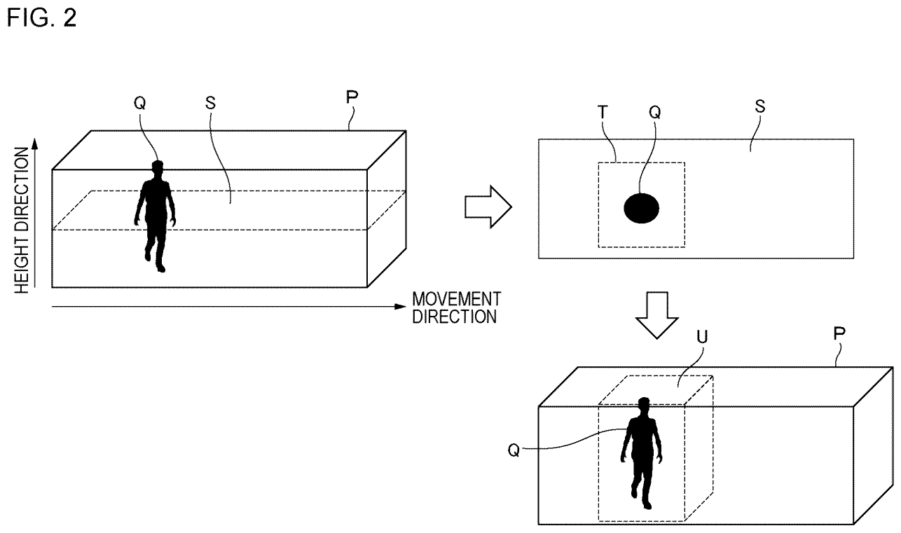

A radar imaging apparatus 10 of a second example embodiment is a more specific embodiment of the radar imaging apparatus 10 of the first example embodiment. An outline of the radar imaging apparatus 10 of the present example embodiment will be described with reference to FIG. 2.

The radar imaging apparatus 10 acquires a radar signal by controlling an antenna (not illustrated) that receives a reflected wave of an electromagnetic wave irradiated to a target space P. Subsequently, based on the radar signal, the radar imaging apparatus 10 generates a two-dimensional image indicating a state of a predetermined height region S that is located at a predetermined height in the target space P and extends in a two-dimensional direction. For example, in a case where a target object Q is a person, a cross section of a predetermined portion of a body of the person is indicated in a two-dimensional image indicating the state of the predetermined height region S. Subsequently, the radar imaging apparatus 10 detects a target object region T including the predetermined target object Q from the two-dimensional image indicating the state of the predetermined height region S.

Subsequently, based on the radar signal, the radar imaging apparatus 10 generates a three-dimensional image indicating a state of a portion (an imaging space U) that is a partial space in the target space P and through which the target object region T passes at a time that the target object region T is moved in a height direction of the target space P. As described above, the target object region T is a region including the target object Q. For this reason, the imaging space U as described above is a space including the target object Q.

As described above, after determining a position of the target object Q, based on a two-dimensional image indicating a state of the predetermined height region S, the radar imaging apparatus 10 generates a three-dimensional image indicating a state of the imaging space U that is a partial space in the target space P and includes the target object Q. An image generated by the imaging apparatus 10 is a two-dimensional image indicating the state of the predetermined height region S and a three-dimensional image indicating the state of the imaging space U being a partial space of the target space P. According to such a radar imaging apparatus 10, a computation amount of a computer can be reduced as compared with a case where a three-dimensional image indicating a state of the entire target space P is generated.

Further, the radar imaging apparatus 10 generates a two-dimensional image indicating a state of the predetermined height region S that is located at a predetermined height in the target space P and extends in the two-dimensional direction, and determines a position of the target object Q, based on the two-dimensional image. According to such a radar imaging apparatus 10, the computation amount of the computer can be reduced without reducing the number of antennas used as in the technique disclosed in Non-Patent Document 2. Since it is not necessary to reduce the number of antennas, it is possible to suppress detection omission of the target object Q.

Further, according to the radar imaging apparatus 10, since the computation amount of the computer can be reduced by the above-described characteristic configuration, even though a width of the target space P becomes sufficiently wider than a radar opening, a problem of a processing load on a computer and a problem of processing time do not become large. According to such a radar imaging apparatus 10, the width of the target space P can become sufficiently wider than the radar opening, and thus the target object Q existing in the target space P can be detected regardless of an orientation of the target object Q.

### “Hardware Configuration”

Next, one example of a hardware configuration of the radar imaging apparatus 10 will be described. Each functional unit of the radar imaging apparatus 10 is achieved by any combination of hardware and software, mainly including a central processing unit (CPU) of any computer, a memory, a program loaded into a memory, a storage unit (capable of storing, in addition to a program stored in advance at a stage of shipping an apparatus, a program downloaded from a storage medium such as a compact disc (CD), a server on the Internet, and the like) such as a hard disk storing the program, and an interface for network connection. Then, it is understood by those skilled in the art that there are various modification examples as a method and an apparatus for achieving the configuration.

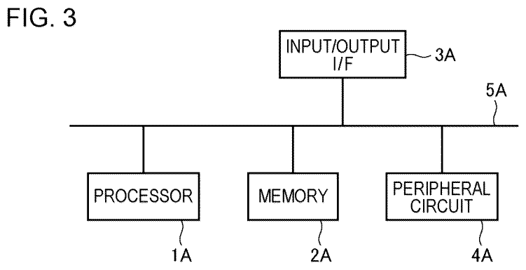

FIG. 3 is a block diagram illustrating a hardware configuration of the radar imaging apparatus 10. As illustrated in FIG. 3, the radar imaging apparatus 10 includes a processor TA, a memory 2A, an input/output interface 3A, a peripheral circuit 4A, and a bus 5A. The peripheral circuit 4A includes various modules. The radar imaging apparatus 10 may not include the peripheral circuit 4A. Note that, the radar imaging apparatus 10 may be configured by a plurality of apparatuses that are physically and/or logically separated. In this case, each of the plurality of apparatuses can include the above-described hardware configuration.

The bus 5A is a data transmission path through which the processor 1A, the memory 2A, the peripheral circuit 4A, and the input/output interface 3A transmit and receive data to and from one another. The processor TA is, for example, an arithmetic processing apparatus such as a CPU or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, a camera, a radar, and the like, an interface for outputting information to an output apparatus, an external apparatus, an external server, a radar, and the like, and the like. The input apparatus is, for example, a keyboard, a mouse, a microphone, a physical button, a touch panel, and the like. The output apparatus is, for example, a display, a speaker, a printer, a mailer, and the like. The processor TA can issue a command to each module, and perform an arithmetic operation, based on an arithmetic operation result of each module.

### “Functional Configuration”

Next, a functional configuration of the radar imaging apparatus 10 of the second example embodiment will be described in detail. FIG. 1 illustrates one example of a functional block diagram of the radar imaging apparatus 10. As illustrated, the radar imaging apparatus 10 includes a radar signal acquisition unit 11, a first image generation unit 12, a target object region detection unit 13, and a second image generation unit 14.

The radar signal acquisition unit 11 acquires a radar signal by controlling an antenna that receives a reflected wave of an electromagnetic wave irradiated to the target space P. The radar signal acquisition unit 11 controls a transmission antenna that irradiates an electromagnetic wave such as a millimeter wave, and a reception antenna that receives a reflected wave of an electromagnetic wave irradiated from the transmission antenna. The radar signal acquisition unit 11 controls, for example, irradiation of an electromagnetic wave from the transmission antenna, specifically, irradiation timing, and the like.

As an electromagnetic wave irradiated by the transmission antenna, for example, a continuous wave (CW), a frequency modulated continuous wave (FMCW), a stepped frequency continuous wave (SFCW), and the like can be used. The reception antenna measures complex amplitude (complex number representing amplitude and a phase shift from a transmission wave) of a reception wave for each frequency, and uses a measurement result as a radar signal. The radar signal can be represented as S(n, m, f) using a number n of the transmission antenna, a number m of the reception antenna, and the frequency f, as arguments.

A configuration of the antenna is not particularly limited, and any configuration can be adopted. For example, an antenna panel R in which a plurality of transmission antennas and a plurality of reception antennas are arranged may be adopted.

The plurality of antennas are installed at a position and an orientation at which an electromagnetic wave is irradiated to the target space P and a reflected wave reflected by the target object Q located in the target space P is received.

The target space P is a space in which a predetermined inspection such as an inspection of personal belongings is performed. By the above-described antenna, the irradiation of an electromagnetic wave to the target space P including the target object Q and the reception of a reflected wave thereof are performed. Then, various inspections are performed based on a radar signal of the reflected wave. The target space P is provided, for example, in a passageway through which the target object Q passes, or the like. Then, while the target object Q moves in the target space P, the irradiation of an electromagnetic wave and the reception of a reflected wave are performed. As described above, in one example of the present example embodiment, a walk-through type inspection is achieved.

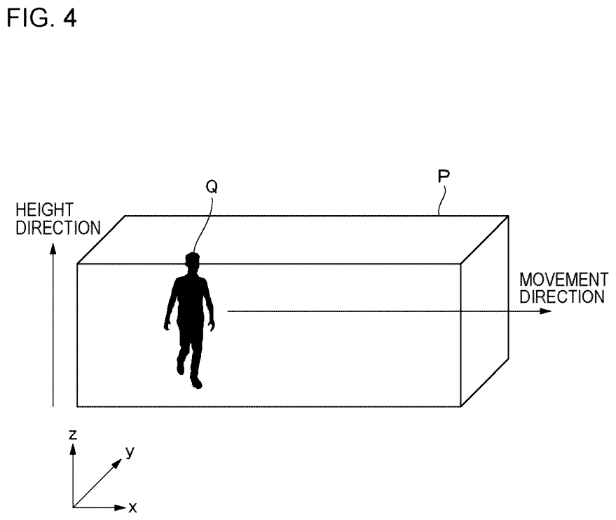

As illustrated in FIG. 4, a shape of the target space P is, for example, a quadrangular prism, but may be another columnar body such as a cylinder, a triangular prism, or the like. The target space P is uniform in the height direction. In other words, a cross sections of all heights have the same shape and the same size. In the present example embodiment, it is assumed that, with respect to the target space P of such a columnar body, a coordinate system in which an x axis is taken in a movement direction of the target object Q, a y axis is taken in a direction orthogonal to the x axis and parallel to a bottom surface of the columnar body, and a z axis is taken in the height direction of the columnar body (the same as the height direction of the target space P) is set.

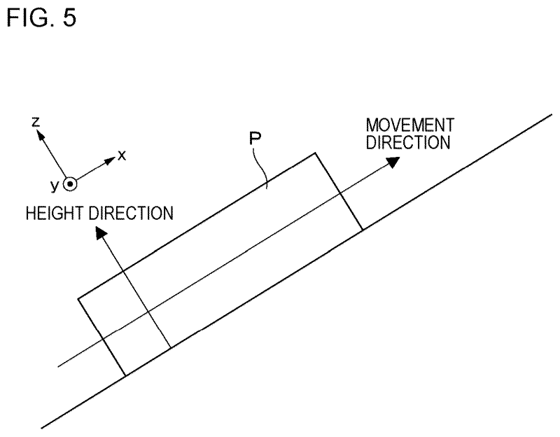

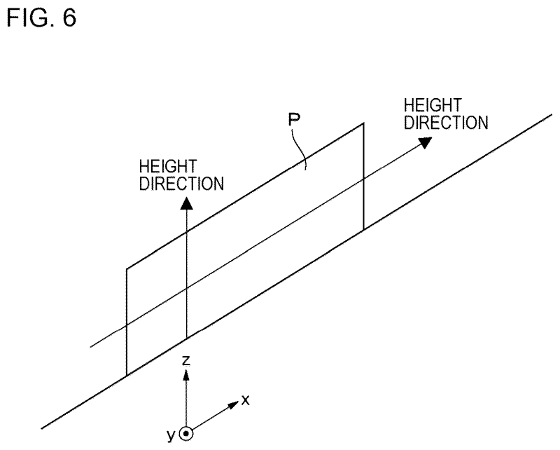

Note that, an xy plane is parallel to the movement direction of the target object Q. The xy plane may be a horizontal plane as illustrated in FIG. 4, or may not be the horizontal plane. For example, as illustrated in FIGS. 5 and 6, In a case where the target space P is set in an escalator, a staircase, an inclined passageway, or the like, the movement direction of the target object Q is not a horizontal direction, but is a direction inclined from the horizontal direction. Note that, in FIGS. 5 and 6, the movement direction is upward, but the movement direction may be downward.

The target space P may be divided into elements such as voxels in such a way as to be able to perform image computation, and a representative coordinate may be defined for each element. A set of the representative coordinates can be expressed by the following expression (1).

$$\begin{matrix}[ Mathematical 1 ] & \\ \{ ( x , y , z ) \vert ( x , y ) ∈ {P}_{XY} , z ∈ {P}_{z} \} & Expression ( 1 )\end{matrix}$$

For example, in a case of dividing into voxels of Nₓ×N_{y}×N_{z} cells at equal intervals in each direction, P_{XY} and P_{Z} of the expression (1) can be expressed as the following expression (2). Note that, although an example of dividing into voxels has been described herein, it may be expressed by another coordinate system such as a polar coordinate.

$$\begin{matrix}[ Mathematical 2 ] & \\ {P}_{XY} = \{ ( {x}_{0} + i Δ x , {y}_{0} + j Δ y ) \vert 0 \leq i < {N}_{x} , 0 \leq j < {N}_{y} \} , & Expression ( 2 )\end{matrix}$$

$${P}_{Z} = \{ {z}_{0} + k Δ z \vert 0 \leq k < {N}_{Z} \}$$

Returning back to FIG. 1, the first image generation unit 12 generates, based on a radar signal acquired by the radar signal acquisition unit 11, a two-dimensional image indicating a state of the predetermined height region S that is located at a predetermined height in the target space P and extends in the two-dimensional direction. The two-dimensional direction is an x axis direction and a y axis direction described above.

In the present example embodiment, the predetermined height is a predetermined fixed value, and is decided based on a size of the target object Q, a pose of the target object Q at a time of moving in the target space P, and the like. For example, in a case where it is a premise that the target object Q is a person and the target object Q moves in the target space P in a standing state (e.g., walking), the predetermined height may be a height assumed as a vicinity of a waist or an abdomen of a standing person.

The first image generation unit 12 may generate “one two-dimensional image indicating a state of one predetermined height region S that is located at one predetermined height in the target space P and extends in the two-dimensional direction”. In addition, the first image generation unit 12 may generate “a plurality of two-dimensional images indicating a state of each of a plurality of predetermined height regions S that are located at each of a plurality of predetermined heights in the target space P and extend in the two-dimensional direction”.

As an example of a case of generating a plurality of two-dimensional images, there is an example in which a two-dimensional image in the vicinity of the waist or the abdomen of a standing person (e.g., the predetermined height of about 1.0 m) and a two-dimensional image in the vicinity of a leg of the standing person (e.g., the predetermined height of about 0.5 m) are generated.

In a case of generating a two-dimensional image in the vicinity of the waist or the abdomen of a person, since a movement of the waist or the abdomen of the person is relatively small, it is possible to stably determine a position of the target object Q, based on the two-dimensional image. Further, in a case of generating a two-dimensional image in the vicinity of the leg of a person, not only detection (position determination) of the leg of the person, but also detection of baggage such as a carry bag placed on the ground is possible.

Generation of a two-dimensional image based on a radar signal is achieved by using any technique disclosed in Patent Document 1 and Non-Patent Document 1.

For example, a radar image I(x, y, z) is generated from the radar signal S(n, m, f), based on the following expression (3).

$$\begin{matrix}[ Mathematical 3 ] & \\ I ( x , y , z ) = {\sum }_{n} {\sum }_{m} {\sum }_{f} s ( n , m , f ) exp [ i \frac{2 π f}{c} {R}_{nm} ( x , y , z ) ] & Expression ( 3 )\end{matrix}$$

As described above, S(n, m, f) is a radar signal represented by the number n of the transmission antenna, the number m of the reception antenna, and the frequency f, as arguments. R_{n,m}(x, y, z) is a sum of a distance from an n-th transmission antenna to a coordinates (x, y, z), and a distance from the coordinates (x, y, z) to an m-th reception antenna. c is a light velocity.

The target object region detection unit 13 detects the target object region T including the predetermined target object Q from a two-dimensional image generated by the first image generation unit 12. The target object region T is a region with a predetermined shape and predetermined size including the target object Q. The predetermined shape is, for example, a quadrangle, but may be another shape such as a circle. The predetermined shape and the predetermined size are determined in advance. Note that, the target object region T is a partial region of the predetermined height region S.

The target object region detection unit 13 may execute any one of the following processing examples 1 to 3, for example.

Note that, as a premise matter of the processing examples 1 to 3, the target object region detection unit 13 processes a two-dimensional image generated by the first image generation unit 12, and detects the target object region T. The two-dimensional image generated by the first image generation unit 12 can be represented as I(x, y). Note that, in a case where the first image generation unit 12 generates a plurality of two-dimensional images associated to each of a plurality of predetermined heights in the target space P, the target object region detection unit 13 projects the plurality of two-dimensional images by any method, generates one two-dimensional image I(x, y), and then performs the following processing. Examples of a projection method include a method of computing a statistical value (a maximum value, a minimum value, an average value, a median value, a mode value, a sum, and the like) of data of the same coordinates (coordinates where x and y coincide with each other) of a plurality of two-dimensional images, a statistical value of an absolute value of the data, a statistical value of a value acquired by squaring the data, and the like.

### Processing Example 1

First, the target object region detection unit 13 determines coordinates (x, y) at which I(x, y) becomes a predetermined condition (e.g., a maximum, a predetermined value or more), that is, coordinates (x, y) at which intensity of a reflected wave satisfies a predetermined condition (e.g., a maximum, a predetermined value or more). Then, the target object region detection unit 13 detects, as the target object region T, a predetermined region including the determined coordinates (x, y), for example, a region with a predetermined shape and a predetermined size centered on the determined coordinates (x, y).

Note that, the target object region detection unit 13 may determine a plurality of coordinates (x, y) at which the intensity of a reflected wave satisfies the predetermined condition (e.g., the maximum, the predetermined value or more). Then, the target object region detection unit 13 may detect a plurality of the target object regions T including each of a plurality of the determined coordinates.

In a case where the entire region of the target space P is divided into voxels at equal intervals, and the target object region T is a quadrangular region of Lₓ×L_{y} cells in the xy plane, the following applies. Note that, Lx is a length (the number of cells) of the target object region T in the x axis direction, and Ly is a length of the target object region T in the y axis direction.

First, a coordinate number associated to coordinates (x_{M}, y_{M}) at which I(x, y) becomes a maximum is denoted as (i_{M}, j_{M}). In other words, x_{M}=x₀+i_{M}Δx, y_{M}=y₀+i_{M}Δy.

As i′_{M}=i_{M}−Lx/2, j′_{M}=j_{M}−Ly/2, it is possible to set R_{XY} as in the following expression (4). A region indicated by R_{XY} becomes the target object region T.

$$\begin{matrix}[ Mathematical 4 ] & \\ {R}_{XY} = \{ ( {x}_{0} + i Δ x , {y}_{0} + j Δ y ) \vert {i}_{M}^{′} \leq i < {i}_{M}^{′} + {L}_{x} , {j}_{M}^{′} \leq j < {j}_{M}^{′} + {L}_{y} \} & Expression ( 4 )\end{matrix}$$

Note that, depending on a value of (i′_{M}, j′_{M}), a part of the region indicated by the R_{XY} may protrude from the target space P. In a case where a part of the region indicated by the R_{XY} protrudes from the target space P, the target object region detection unit 13 may execute processing (clipping processing) of correcting the value of (i′_{M}, j′_{M}) in a range that does not protrude.

### Processing Example 2

First, the target object region detection unit 13 sets a plurality of observation regions with a predetermined shape and a predetermined size in a two-dimensional image. Subsequently, the target object region detection unit 13 computes, for each observation region, a sum or an average of I(x, y) being the coordinates included in each observation region, that is, a sum or an average of pieces of intensity of reflected waves. Then, the target object region detection unit 13 detects, as the target object region T, an observation region at which the sum or average of pieces of the intensity of the reflected waves satisfies a predetermined condition (e.g., a maximum or a predetermined value or more). Note that, the target object region detection unit 13 may detect one observation region as the target object region T, or may detect a plurality of observation regions as the target object region T.

### Processing Example 3

The target object region detection unit 13 may perform contour detection processing or the like on a two-dimensional image, and detect, as the target object region T, a region satisfying a predetermined condition (e.g., a predetermined size or larger) surrounded by a contour.

Returning back to FIG. 1, the second image generation unit 14 generates, based on a radar signal acquired by the radar signal acquisition unit 11, a three-dimensional image indicating a state of a portion (imaging space U) that is a partial space in the target space P and through which the target object region T passes at a time that the target object region T detected by the target object region detection unit 13 is moved in the height direction of the target space P.

FIG. 2 illustrates a relationship among the target space P, the target object Q, the predetermined height region S, the target object region T, and the imaging space U. The imaging space U being a portion through which the target object region T passes at a time that the target object region T is moved in the height direction of the target space P becomes a columnar body as illustrated. Then, by appropriately setting a shape and size of the target object region T, the imaging space U includes the target object Q. Note that, a portion through which the target object region T does not pass at a time that the target object region T is moved in the height direction of the target space P is not included in the imaging space U. In the present example embodiment, a height of the imaging space U is the same as the height of the target space P.

Generation of a three-dimensional image based on a radar signal is achieved by using any technique disclosed in Patent Document 1 and Non-Patent Document 1. Note that, the radar image I(x, y, z) may be generated from the radar signal S(n, m, f), based on the above-described expression (3).

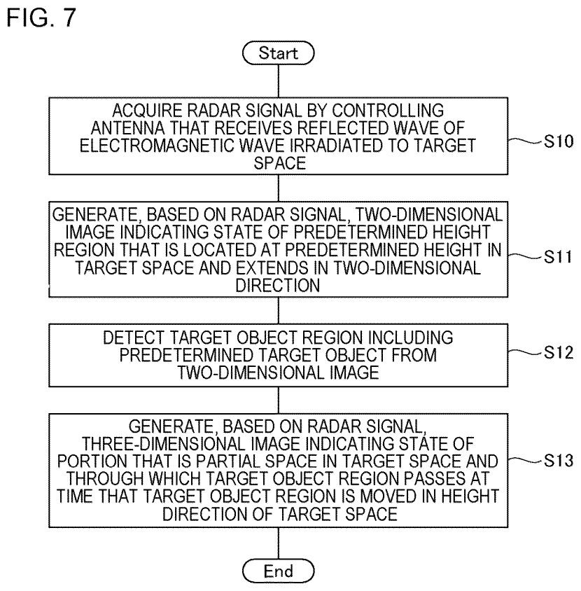

Next, one example of a flow of processing of the radar imaging apparatus 10 will be described with reference to a flowchart in FIG. 7.

First, the radar imaging apparatus 10 acquires a radar signal by controlling an antenna that irradiates an electromagnetic wave to the target space P and also receives a reflected wave (S10).

Subsequently, based on the radar signal acquired in S10, the radar imaging apparatus 10 generates a two-dimensional image indicating a state of the predetermined height region S that is located at a predetermined height in the target space P and extends in the two-dimensional direction (S11).

Subsequently, the radar imaging apparatus 10 detects the target object region T including the predetermined target object Q from the two-dimensional image generated in S11 (S12).

Subsequently, based on the radar signal acquired in S10, the radar imaging apparatus 10 generates a three-dimensional image indicating a state of a portion (imaging space U) that is a partial space in the target space P and through which the target object region T passes at a time that the target object region T is moved in the height direction of the target space P (S13).

Based on the three-dimensional image generated in this manner, various inspections such as an inspection of personal belongings are executed. The details of the various inspections based on the three-dimensional image are not particularly limited, and any technique can be adopted.

### Advantageous Effect

After determining a position of the target object Q, based on a two-dimensional image indicating a state of the predetermined height region S, the radar imaging apparatus 10 generates a three-dimensional image indicating a state of the imaging space U that is a partial space of the target space P and includes the target object Q. An image generated by the imaging apparatus 10 is a two-dimensional image indicating the state of the predetermined height region S and a three-dimensional image indicating the state of the imaging space U being a partial space of the target space P. According to such a radar imaging apparatus 10, a computation amount of a computer can be reduced as compared with a case where a three-dimensional image indicating a state of the entire target space P is generated.

Further, the radar imaging apparatus 10 generates a two-dimensional image indicating a state of the predetermined height region S that is located at a predetermined height in the target space P and extends in the two-dimensional direction, and determines a position of the target object Q, based on the two-dimensional image. According to such a radar imaging apparatus 10, the computation amount of the computer can be reduced without reducing the number of antennas used as in the technique disclosed in Non-Patent Document 2. Since it is not necessary to reduce the number of antennas, it is possible to suppress detection omission of the target object Q.

Further, according to the radar imaging apparatus 10, since the computation amount of the computer can be reduced by the above-described characteristic configuration, even though a width of the target space P becomes sufficiently wider than a radar opening, a problem of a processing load on a computer and a problem of processing time do not become large. According to such a radar imaging apparatus 10, the width of the target space P can become sufficiently wider than the radar opening, and thus the target object Q existing in the target space P can be detected regardless of an orientation of the target object Q.

### Third Example Embodiment

A radar imaging apparatus 10 according to a third example embodiment reduces a computation amount of a computer by making a height of an imaging space U lower than a height of a target space P. Hereinafter, the details will be described.

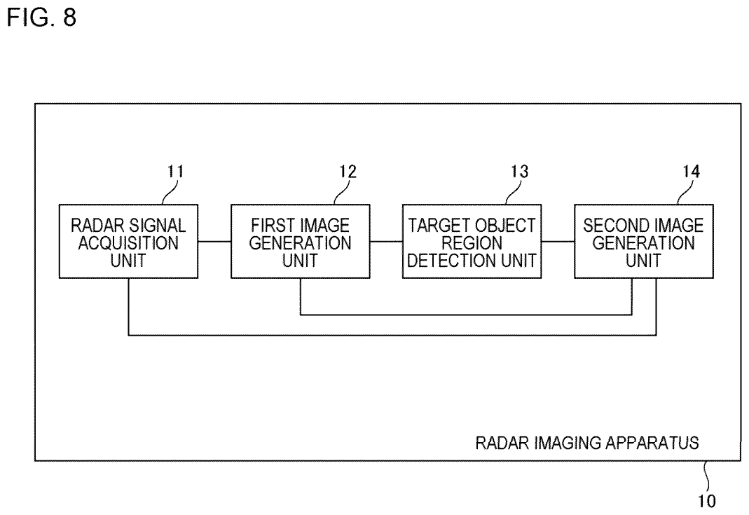

FIG. 8 illustrates one example of a functional block diagram of the radar imaging apparatus 10 of the present example embodiment. As illustrated, the radar imaging apparatus 10 includes a radar signal acquisition unit 11, a first image generation unit 12, a target object region detection unit 13, and a second image generation unit 14. The functional block diagram in FIG. 8 is different from the functional block diagram in FIG. 1 in that the first image generation unit 12 and the second image generation unit 14 are connected to each other by a line indicating data transfer.

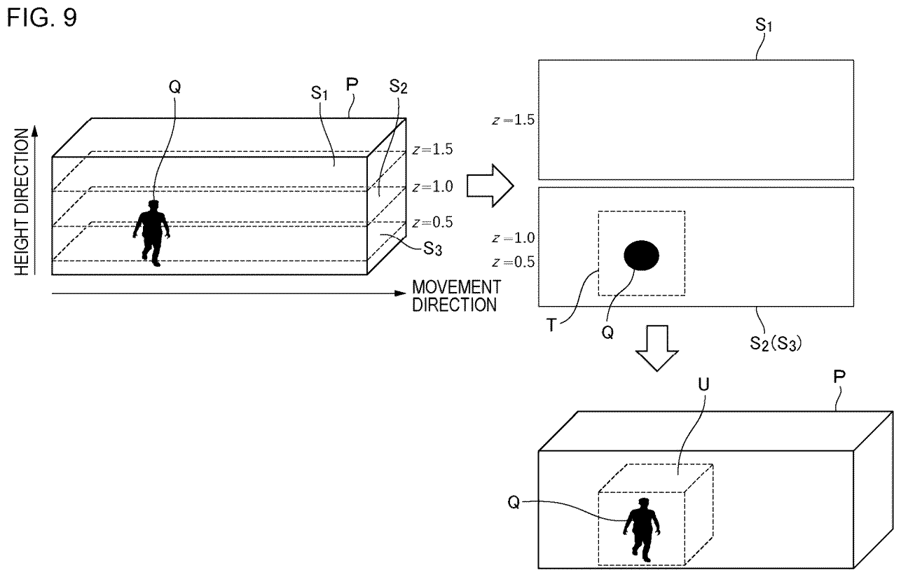

The first image generation unit 12 generates a plurality of two-dimensional images indicating a state of a plurality of predetermined height regions S that are located at each of a plurality of predetermined heights. In an example illustrated in FIG. 9, three two-dimensional images indicating a state of each of three predetermined height regions S₁ to S₃ that are located at each of three predetermined heights of z=0.5, 1.0, and 1.5 [m] are generated. Note that, the number of predetermined heights and a value of each of the predetermined heights illustrated in FIG. 9 are merely examples, and are not limited thereto. The plurality of predetermined heights are determined in advance.

The target object region detection unit 13 detects a target object region T from each of the plurality of two-dimensional images generated by the first image generation unit 12.

The second image generation unit 14 decides a height M of a three-dimensional image to be generated, based on a detection result of whether the target object region T is detected from each of the plurality of two-dimensional images. Then, the second image generation unit 14 generates a three-dimensional image indicating a state of a portion (imaging space U) through which the target object region T passes at a time that the target object region T is moved from a bottom surface of the target space P in a height direction by M. Specifically, the second image generation unit 14 acquires a plurality of predetermined height values from the first image generation unit 12. Further, the second image generation unit 14 acquires, from the target object region detection unit 13, a detection result of whether the target object region T is detected from each of the plurality of two-dimensional images associated to each of the plurality of predetermined heights. Then, the second image generation unit 14 decides the above-described M, based on the acquired information. Note that, in a case where a height of the target space P is H, M is any value satisfying M≤H. In other words, the second image generation unit 14 can set a value lower than the height H of the target space P as the height M of the three-dimensional image.

For example, the second image generation unit 14 may determine, from the plurality of predetermined heights, a predetermined height at which the target object region T is not detected, and then set the determined lowest predetermined height to M. The processing will be described with reference to FIG. 9.

In the example in FIG. 9, three predetermined heights of z=0.5, 1.0, and 1.5 [m] are set. Then, the target object region T is detected at z=0.5, 1.0, but the target object region T is not detected at z=1.5. In this case, the second image generation unit 14 sets 1.5 to M.

As another example, it is assumed that five predetermined heights of z=0.5, 1.0, 1.5, 2.0, and 2.5 [m] are set, and the target object region T is detected at z=0.5 and 1.0, but the target object region T is not detected at z=1.5, 2.0, and 2.5. In this case, the second image generation unit 14 sets, to M, the lowest 1.5 among 1.5, 2.0, and 2.5 in which the target object region T is not detected.

### Modification Example

The radar imaging apparatus 10 may decide M by the following processing. For example, a height of the target object Q existing in the target space P may be detected by using another sensor such as a visible light camera. Then, the radar imaging apparatus 10 may acquire information indicating the detected height of the target object Q.

The second image generation unit 14 decides M, based on the detected height of the target object Q. For example, the second image generation unit 14 may set, to M, a value acquired by adding a (a predetermined value) to the detected height of the target object Q. In addition, the second image generation unit 14 may set, to M, a value acquired by multiplying the detected height of the target object Q by β (a predetermined value of one or more). Note that, the computation example herein is merely one example, and is not limited thereto. The detected height of the target object Q is not set to M, but a value slightly larger than the detected height of the target object Q is set to M, and thereby inconvenience that the target object Q protrudes from the imaging space U is suppressed.

In a case of the modification example, the first image generation unit 12 does not need to generate a plurality of two-dimensional images associated to a plurality of predetermined heights, and may generate one two-dimensional image associated to one predetermined height.

Other configurations of the radar imaging apparatus 10 of the present example embodiment are similar to the configurations of the radar imaging apparatus 10 of the first and second example embodiments.

According to the radar imaging apparatus 10 of the present example embodiment, an advantageous effect similar to that of the radar imaging apparatus 10 of the first and second example embodiments can be achieved. Further, according to the radar imaging apparatus 10 of the present example embodiment, a computation amount of a computer can be reduced by lowering the height of the imaging space U.

### Fourth Example Embodiment

A radar imaging apparatus 10 according to a fourth example embodiment changes a “predetermined height” for determining a predetermined height region S generating a two-dimensional image in response to a target object Q existing in a target space P. Hereinafter, the details will be described.

A first image generation unit 12 acquires information indicating a height of the target object Q being detected by a predetermined sensor and located in the target space P. The sensor is, but not limited to, a visible light camera or the like. The above information in a case where the sensor is a visible light camera is an image. Before the target object Q enters the target space P, the sensor is installed at a position and a direction in which information indicating the height of the target object Q can be acquired. The sensor and the radar imaging apparatus 10 are configured to be communicably with each other. The sensor transmits the generated information to the radar imaging apparatus 10. The first image generation unit 12 computes the height of the target object Q, based on the acquired information. Processing of computing a height of an object (such as a height of a person) capturing in an image by analyzing the image is achieved by using any technique.

Then, the first image generation unit 12 decides a predetermined height, based on the height of the target object Q determined by the acquired information. As a result, a predetermined height region S in which the two-dimensional image is generated is decided.

The first image generation unit 12 decides a predetermined height, based on a predetermined rule. The rule may be, for example, “a height (h/2) in the middle of the height (h) of the target object Q”, or may be another rule.

Other configurations of the radar imaging apparatus 10 of the present example embodiment are similar to the configurations of the radar imaging apparatus 10 of the first to third example embodiments.

According to the radar imaging apparatus 10 of the present example embodiment, an advantageous effect similar to that of the radar imaging apparatus 10 of the first to third example embodiments can be achieved. Further, according to the radar imaging apparatus 10 of the present example embodiment, it is possible to appropriately set a “predetermined height” for determining the predetermined height region S generating a two-dimensional image in response to a detection result of the height of the target object Q. As a result, a position of the target object Q in the target space P can be accurately determined.

### Fifth Example Embodiment

A radar imaging apparatus 10 of a fifth example embodiment has a function of generating a two-dimensional projection image by projecting a three-dimensional image generated by a second image generation unit 14 in a predetermined projection direction. Then, the radar imaging apparatus 10 decides the projection direction, based on a position of a target object region T in a two-dimensional image generated by a first image generation unit 12. Hereinafter, the details will be described.

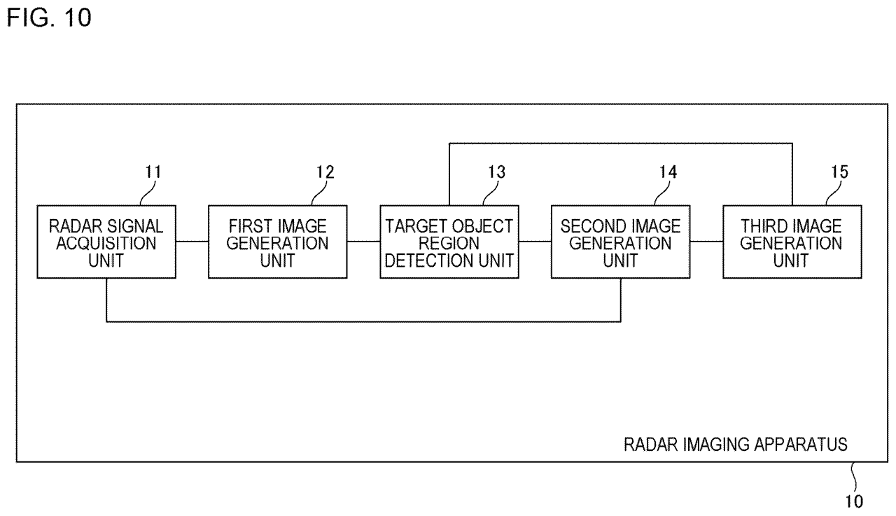

FIG. 10 illustrates one example of a functional block diagram of the radar imaging apparatus 10 of the present example embodiment. As illustrated, the radar imaging apparatus 10 includes a radar signal acquisition unit 11, the first image generation unit 12, a target object region detection unit 13, the second image generation unit 14, and a third image generation unit 15. Note that, the first image generation unit 12 and the second image generation unit 14 may be connected to each other by a line indicating data transfer.

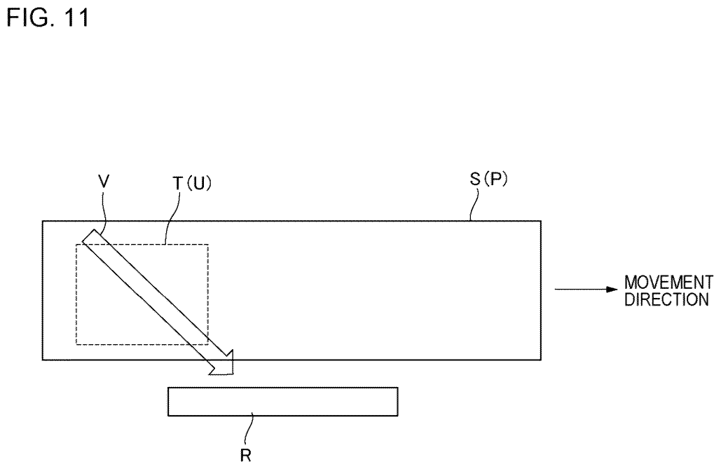

As illustrated in FIG. 11, the third image generation unit 15 generates a two-dimensional projection image by projecting a three-dimensional image of an imaging space U generated by the second image generation unit 14 in a predetermined projection direction V. The third image generation unit 15 decides the projection direction V, based on a position of the target object region T in a two-dimensional image of a predetermined height region S.

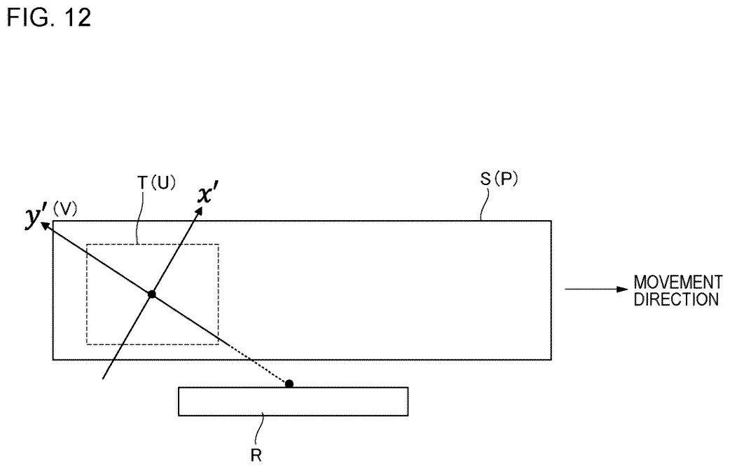

Specifically, as illustrated in FIG. 12, the target object region detection unit 13 can decide, as the projection direction V, a direction (y′ direction in the drawing) connecting any position (e.g., center) on an antenna panel R configured by a plurality of antennas arranged side by side and any position (e.g., center) on the target object region T. Processing of generating a two-dimensional projection image by projecting a three-dimensional image in the predetermined projection direction V is not particularly limited, and any technique can be adopted.

According to the radar imaging apparatus 10 of the present example embodiment, an advantageous effect similar to that of the radar imaging apparatus 10 of the first to fourth example embodiments can be achieved. Further, according to the radar imaging apparatus 10 of the present example embodiment, in processing of generating a two-dimensional projection image by projecting a generated three-dimensional image in a predetermined projection direction, it is possible to appropriately set the projection direction. An angle of a surface on which reflection is easy to be taken changes in response to a position of the target object region T. For this reason, by deciding an optimum projection direction V in response to the position of the target object region T and generating a two-dimensional projection image, it is possible to convert a three-dimensional image into a two-dimension with little reduction in information due to captured reflection. By generating a two-dimensional projection image by converting a three-dimensional image into a two-dimension, application of image processing algorithm such as image drawing processing and object detection is facilitated.

### Modification Example

Herein, a modification example applicable to all example embodiments will be described. In the above-described example embodiments, it is a premise that a target object Q moves in a target space P, but the premise may not be made. For example, a predetermined inspection may be performed on the target object Q placed at any position in the target space P in any orientation.

Although the example embodiments of the present invention have been described above with reference to the drawings, these are examples of the present invention, and various configurations other than the above may be adopted. The configurations of the above-described example embodiments may be combined with each other, or some of the configurations may be replaced with other configurations. Further, the configuration of the above-described example embodiments may be variously modified within a range not departing from the gist. Further, the configurations and processing disclosed in each of the example embodiments and modification example described above may be combined with each other.

Further, in the flowchart used in the above description, a plurality of steps (pieces of processing) are described in order, but the execution order of the steps executed in each example embodiment is not limited to the described order. In each of the example embodiments, the order of the illustrated steps can be changed within a range that does not interfere with the contents. Further, the above-described example embodiments can be combined within a range in which the contents do not conflict with each other.

Some or all of the above-described example embodiments may be described as the following supplementary notes, but are not limited thereto.
1. A radar imaging apparatus including:
   a radar signal acquisition unit that acquires a radar signal by controlling an antenna that receives a reflected wave of an electromagnetic wave irradiated to a target space;
   a first image generation unit that generates, based on the radar signal, a two-dimensional image indicating a state of a predetermined height region that is located at a predetermined height in the target space and extends in a two-dimensional direction;
   a target object region detection unit that detects a target object region including a predetermined target object from the two-dimensional image; and
   a second image generation unit that generates, based on the radar signal, a three-dimensional image indicating a state of a portion that is a partial space in the target space and through which the target object region passes at a time that the target object region is moved in a height direction of the target space.
2. The radar imaging apparatus according to supplementary note 1, wherein
   the first image generation unit generates a plurality of two-dimensional images indicating a state of each of a plurality of the predetermined height regions that are located at each of the predetermined heights,
   the target object region detection unit detects the target object region from each of a plurality of the two-dimensional images, and
   the second image generation unit decides a height of the three-dimensional image, based on a detection result of whether the target object region is detected from each of a plurality of the two-dimensional images.
3. The radar imaging apparatus according to supplementary note 1 or 2, wherein
   the first image generation unit
      acquires information indicating a height of the target object being detected by a predetermined sensor and located in the target space, and
      decides, based on a height of the target object, the predetermined height of the target space in which the two-dimensional image is generated.
4. The radar imaging apparatus according to any one of supplementary notes 1 to 3, further including
   a third image generation unit that generates a two-dimensional projection image by projecting the three-dimensional image in a predetermined projection direction, wherein
   the third image generation unit decides the projection direction, based on a position of the target object region in the two-dimensional image.
5. The radar imaging apparatus according to any one of supplementary notes 1 to 4, wherein
   the target object region detection unit
   determines, from the two-dimensional image, a position where intensity of the reflected wave satisfies a predetermined condition, and
   detects, as the target object region, a predetermined region including the determined position.
6. The radar imaging apparatus according to any one of supplementary notes 1 to 4, wherein
   the target object region detection unit
   sets a plurality of observation regions with a predetermined shape and a predetermined size in the two-dimensional image,
   computes a sum or an average of pieces of intensity of the reflected waves, for each observation region, and
      detects, as the target object region, the observation region in which a sum or an average of pieces of intensity of the reflected waves satisfies a predetermined condition.
7. The radar imaging apparatus according to any one of supplementary notes 1 to 6, wherein
   the target object is a person, and
   the radar signal acquisition unit acquires the radar signal by controlling the antenna that irradiates an electromagnetic wave to a person moving in the target space and also receives a reflected wave.
8. The radar imaging apparatus according to any one of supplementary notes 1 to 7, wherein
   the target object region is a partial region of the predetermined height region.
9. A radar imaging method including,
   by a computer:
      acquiring a radar signal by controlling an antenna that receives a reflected wave of an electromagnetic wave irradiated to a target space;
      generating, based on the radar signal, a two-dimensional image indicating a state of a predetermined height region that is located at a predetermined height of the target space and extends in a two-dimensional direction;
      detecting a target object region including a predetermined target object from the two-dimensional image; and
      generating, based on the radar signal, a three-dimensional image indicating a state of a portion that is a partial space in the target space and through which the target object region passes at a time that the target object region is moved in a height direction of the target space.
10. A program causing a computer to function as:
   a radar signal acquisition unit that acquires a radar signal by controlling an antenna that receives a reflected wave of an electromagnetic wave irradiated to a target space;
   a first image generation unit that generates, based on the radar signal, a two-dimensional image indicating a state of a predetermined height region that is located at a predetermined height in the target space and extends in a two-dimensional direction;
   a target object region detection unit that detects a target object region including a predetermined target object from the two-dimensional image; and
   a second image generation unit that generates, based on the radar signal, a three-dimensional image indicating a state of a portion that is a partial space in the target space and through which the target object region passes at a time that the target object region is moved in a height direction of the target space.

This application is based upon and claims the benefit of priority from Japanese patent application No. 2022-078309, filed on May 11, 2022, the disclosure of which is incorporated herein in its entirety by reference.

### REFERENCE SIGNS LIST

10 Radar imaging apparatus
11 Radar signal acquisition unit
12 First image generation unit
13 Target object region detection unit
14 Second image generation unit
15 Third image generation unit
1A Processor
2A Memory
3A Input/Output I/F
4A Peripheral circuit
5A Bus

What is claimed is:

1. A radar imaging apparatus comprising:
at least one memory configured to store one or more instructions; and
at least one processor configured to execute the one or more instructions to:
acquire a radar signal by controlling an antenna that receives a reflected wave of an electromagnetic wave irradiated to a target space;
generate, based on the radar signal, a two-dimensional image indicating a state of a predetermined height region that is located at a predetermined height in the target space and extends in a two-dimensional direction;
detect a target object region including a predetermined target object from the two-dimensional image; and
generate, based on the radar signal, a three-dimensional image indicating a state of a portion that is a partial space in the target space and through which the target object region passes at a time that the target object region is moved in a height direction of the target space.

2. The radar imaging apparatus according to claim 1, wherein the at least one processor is further configured to execute the one or more instructions to
generate a plurality of two-dimensional images indicating a state of each of a plurality of the predetermined height regions that are located at each of the predetermined heights,
detect the target object region from each of a plurality of the two-dimensional images, and
decide a height of the three-dimensional image, based on a detection result of whether the target object region is detected from each of a plurality of the two-dimensional images.

3. The radar imaging apparatus according to claim 1, wherein
the at least one processor is further configured to execute the one or more instructions to
acquire information indicating a height of the target object being detected by a predetermined sensor and located in the target space, and
decide, based on a height of the target object, the predetermined height of the target space in which the two-dimensional image is generated.

4. The radar imaging apparatus according to claim 1, wherein the at least one processor is further configured to execute the one or more instructions to
generate a two-dimensional projection image by projecting the three-dimensional image in a predetermined projection direction, and
decide the projection direction, based on a position of the target object region in the two-dimensional image.

5. The radar imaging apparatus according to claim 1, wherein
the at least one processor is further configured to execute the one or more instructions to
determine, from the two-dimensional image, a position where intensity of the reflected wave satisfies a predetermined condition, and
detect, as the target object region, a predetermined region including the determined position.

6. The radar imaging apparatus according to claim 1, wherein
the at least one processor is further configured to execute the one or more instructions to
set a plurality of observation regions with a predetermined shape and a predetermined size in the two-dimensional image,
compute a sum or an average of pieces of intensity of the reflected waves, for each observation region, and
detect, as the target object region, the observation region in which a sum or an average of pieces of intensity of the reflected waves satisfies a predetermined condition.

7. The radar imaging apparatus according to claim 1, wherein
the target object is a person, and
the at least one processor is further configured to execute the one or more instructions to acquire the radar signal by controlling the antenna that irradiates an electromagnetic wave to a person moving in the target space and also receives a reflected wave.

8. The radar imaging apparatus according to claim 1, wherein
the target object region is a partial region of the predetermined height region.

9. A radar imaging method comprising,
by a computer:
acquiring a radar signal by controlling an antenna that receives a reflected wave of an electromagnetic wave irradiated to a target space;
generating, based on the radar signal, a two-dimensional image indicating a state of a predetermined height region that is located at a predetermined height in the target space and extends in a two-dimensional direction;
detecting a target object region including a predetermined target object from the two-dimensional image; and
generating, based on the radar signal, a three-dimensional image indicating a state of a portion that is a partial space in the target space and through which the target object region passes at a time that the target object region is moved in a height direction of the target space.

10. A non-transitory computer-readable medium storing a program causing a computer to:
acquire a radar signal by controlling an antenna that receives a reflected wave of an electromagnetic wave irradiated to a target space;
generate, based on the radar signal, a two-dimensional image indicating a state of a predetermined height region that is located at a predetermined height in the target space and extends in a two-dimensional direction;
detect a target object region including a predetermined target object from the two-dimensional image; and
generate, based on the radar signal, a three-dimensional image indicating a state of a portion that is a partial space in the target space and through which the target object region passes at a time that the target object region is moved in a height direction of the target space.

11. The radar imaging method according to claim 9, wherein the computer
generates a plurality of two-dimensional images indicating a state of each of a plurality of the predetermined height regions that are located at each of the predetermined heights,
detects the target object region from each of a plurality of the two-dimensional images, and
decides a height of the three-dimensional image, based on a detection result of whether the target object region is detected from each of a plurality of the two-dimensional images.

12. The radar imaging method according to claim 9, wherein
the computer
acquires information indicating a height of the target object being detected by a predetermined sensor and located in the target space, and
decides, based on a height of the target object, the predetermined height of the target space in which the two-dimensional image is generated.

13. The radar imaging method according to claim 9, wherein the computer
generates a two-dimensional projection image by projecting the three-dimensional image in a predetermined projection direction, and
decides the projection direction, based on a position of the target object region in the two-dimensional image.

14. The radar imaging method according to claim 9, wherein
the computer
determines, from the two-dimensional image, a position where intensity of the reflected wave satisfies a predetermined condition, and
detects, as the target object region, a predetermined region including the determined position.

15. The radar imaging method according to claim 9, wherein
the computer
sets a plurality of observation regions with a predetermined shape and a predetermined size in the two-dimensional image,
computes a sum or an average of pieces of intensity of the reflected waves, for each observation region, and
detects, as the target object region, the observation region in which a sum or an average of pieces of intensity of the reflected waves satisfies a predetermined condition.

16. The non-transitory computer-readable medium according to claim 10, wherein the program causing the computer to
generate a plurality of two-dimensional images indicating a state of each of a plurality of the predetermined height regions that are located at each of the predetermined heights,
detect the target object region from each of a plurality of the two-dimensional images, and
decide a height of the three-dimensional image, based on a detection result of whether the target object region is detected from each of a plurality of the two-dimensional images.

17. The non-transitory computer-readable medium according to claim 10, wherein
the program causing the computer to
acquire information indicating a height of the target object being detected by a predetermined sensor and located in the target space, and
decide, based on a height of the target object, the predetermined height of the target space in which the two-dimensional image is generated.

18. The non-transitory computer-readable medium according to claim 10, wherein the program causing the computer to
generate a two-dimensional projection image by projecting the three-dimensional image in a predetermined projection direction, and
decide the projection direction, based on a position of the target object region in the two-dimensional image.

19. The non-transitory computer-readable medium according to claim 10, wherein
the program causing the computer to
determine, from the two-dimensional image, a position where intensity of the reflected wave satisfies a predetermined condition, and
detect, as the target object region, a predetermined region including the determined position.

20. The non-transitory computer-readable medium according to claim 10, wherein
the program causing the computer to
set a plurality of observation regions with a predetermined shape and a predetermined size in the two-dimensional image,
compute a sum or an average of pieces of intensity of the reflected waves, for each observation region, and
detect, as the target object region, the observation region in which a sum or an average of pieces of intensity of the reflected waves satisfies a predetermined condition.
